(19) United States
(12) Patent Application Publication
(10) Pub. No.: US 2025/0272887 A1
(43) Pub. Date: Aug. 28, 2025

(54) IMAGE GENERATION

(71) Applicant: Beijing Zitiao Network Technology Co., Ltd., Beijing (CN)

(72) Inventors: Jiaxiang Cheng, Beijing (CN); Pan Xie, Beijing (CN); Xin Xia, Beijing (CN); Jiashi Li, Beijing (CN); Jie Wu, Beijing (CN); Yuxi Ren, Beijing (CN); Huixia Li, Beijing (CN); Xuefeng Xiao, Beijing (CN)

(21) Appl. No.: 19/053,472

(22) Filed: Feb. 14, 2025

(30) Foreign Application Priority Data
Feb. 22, 2024 (CN) 202410199590.9

(51) Int. Cl. G06T 11/00; G06N 20/00; G06T 3/40

(52) U.S. Cl. CPC G06T 11/00; G06N 20/00; G06T 3/40

(57) ABSTRACT

A method, an apparatus, a device, a medium for generating an image are provided. In a method, a first machine learning model is obtained, the first machine learning model being obtained based on a reference image having a first resolution. The first machine learning model is fine-tuned to a second machine learning model by a fine-tuning plug-in that is obtained based on a reference image having the second resolution. A target image is generated based on a target prompt by a second machine learning model, the target image having a resolution and image content specified by the target prompt. With the example implementations of the disclosure, the fine-tuning plug-in may obtain knowledge related to generating an image(s) with a further resolution(s), so that the second machine learning model may generate images with different resolutions in a more accurate and effective manner.

### CROSS-REFERENCE

The present application claims priority to Chinese Patent Application No. 202410199590.9, filed on Feb. 22, 2024, and entitled “METHOD, APPARATUS, DEVICE, AND MEDIUM FOR GENERATING AN IMAGE”, the entirety of which is incorporated herein by reference.

### FIELD

Example implementations of the present disclosure generally relate to image generation, and more particularly to a method, an apparatus, a device, a computer readable storage medium for generating an image of a different resolution using a machine learning model.

### BACKGROUND

Machine learning techniques have been widely used for image generation. At present, multiple machine learning models for text-to-image generation has been proposed, and an image with content specified by a prompt may be generated by using a machine learning model. However, when there is a large difference between the resolution of the generated image and the resolution of the training image, the quality of the generated image is not satisfactory. To this end, it is desirable to generate an image with any specified resolution and content in a more convenient and efficient manner.

### SUMMARY

In a first aspect of the present disclosure, a method for generating an image is provided. In the method, a first machine learning model is obtained, the first machine learning model being obtained based on a reference image having a first resolution. The first machine learning model is fine-tuned to a second machine learning model by a fine-tuning plug-in that is obtained based on a reference image having the second resolution. A target image is generated based on a target prompt by a second machine learning model, the target image having a resolution and image content specified by the target prompt.

In a second aspect of the present disclosure, an apparatus for generating an image is provided. The apparatus includes: an obtaining module configured to obtain a first machine learning model, the first machine learning model being obtained based on a reference image having a first resolution; a fine-tuning module configured to fine-tune the first machine learning model to a second machine learning model by a fine-tuning plug-in, the fine-tuning plug-in being obtained based on a reference image having a second resolution; and a generation module configured to generate, by the second machine learning model, a target image based on a target prompt, the target image having a resolution and image content specified by the target prompt.

In a third aspect of the present disclosure, an electronic device is provided. The electronic device includes: at least one processing unit; and at least one memory coupled to the at least one processing unit and storing instructions executable by the at least one processing unit, the instructions, when executed by the at least one processing unit, causing the electronic device to perform the method according to the first aspect of the present disclosure.

In a fourth aspect of the present disclosure, there is provided a computer-readable storage medium having a computer program stored thereon, the computer program, when executed by a processor, causes the processor to implement the method according to the first aspect of the present disclosure.

It should be understood that the content described in this Summary section is not intended to limit the key features or important features of the embodiments of the disclosure, nor is it intended to limit the scope of the disclosure. Other features of the present disclosure will be readily envisaged through the following description.

### BRIEF DESCRIPTION OF DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a block diagram of an application environment according to an example implementation of the present disclosure;

FIG. 2 illustrates a block diagram for generating an image according to some implementations of the present disclosure;

FIG. 3 illustrates a block diagram for determining a fine-tuning plug-in according to some implementations of the present disclosure;

FIG. 4A illustrates a block diagram of injecting a fine-tuning plug-in to a first machine learning model according to some implementations of the present disclosure;

FIG. 4B illustrates a block diagram of injecting a fine-tuning plug-in to a first machine learning model according to some implementations of the present disclosure;

FIG. 5 illustrates a block diagram of generating images with different resolutions using a second machine learning model according to some implementations of the present disclosure;

FIG. 6 illustrates a block diagram of images generated using different technical solutions according to some implementations of the present disclosure;

FIG. 7 illustrates a block diagram for generating a high resolution image according to some implementations of the present disclosure;

FIG. 8 illustrates a block diagram of high-resolution images generated with different technical solutions according to some implementations of the present disclosure;

FIG. 9 illustrates a flowchart of a method for generating an image according to some implementations of the present disclosure;

FIG. 10 illustrates a block diagram of an apparatus for generating an image according to some implementations of the present disclosure; and

FIG. 11 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are illustrated in the accompanying drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit the scope of the present disclosure.

In the description of implementations of the present disclosure, the terms “include” and similar terms should be understood to include “including but not limited to”. The term “based on” should be understood as “based at least in part on”. The terms “one implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the above-mentioned association relationship may be obtained based on various technical solutions currently known and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

The term “in response to” as used herein means a state in which a corresponding event occurs or a condition is satisfied. It will be appreciated that the timing of execution of a subsequent action performed in response to the event or condition is not necessarily strongly correlated with the time at which the event occurs or the condition is satisfied. For example, in some cases, the subsequent action may be performed immediately when an event occurs or a condition holds; while in other cases, the subsequent action may be performed after a period of time elapses after an event occurs or a condition is satisfied.

### Example Environment

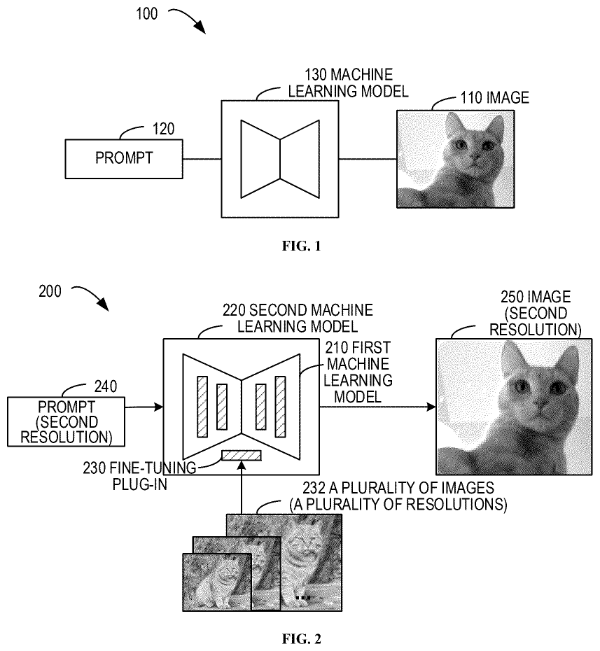

The machine learning model may be utilized to generate images with content specified by the cue words, and a machine learning model of a plurality of text graphs has been proposed at present. FIG. 1 is a block diagram 100 of an application environment according to an example implementation of the present disclosure. As illustrated in FIG. 1, the machine learning model 130 may be a model that performs a text-to-image task, a prompt 120 may be input to the machine learning model 130 to specify image content (e.g., a cat, etc.), so as to generate an image 110 including “cat”.

It should be understood that the machine learning model is typically trained with training images having a predetermined resolution (e.g., 512×512, etc.). These machine learning models are not satisfactory in generating images with other resolutions. For example, in generating high resolution (e.g., 1024×1024), the contents of the image may be repeated or disordered.

In existing solutions, multi-stage fine-tuning is usually used, for example, the machine learning model may be fine-tuned by using reference data of different resolutions in multiple stages. However, this approach is computationally expensive and may have catastrophic forgetting. In other technical solutions, multiple images of a certain resolution may be iteratively generated, and then post-processing is used to generate an image having higher resolution. However, this approach requires a longer inference time and easily generates duplicate objects. At this point, it is desirable to generate an image with any specified resolution and content in a more convenient and efficient manner.

### Summary of Image Generation

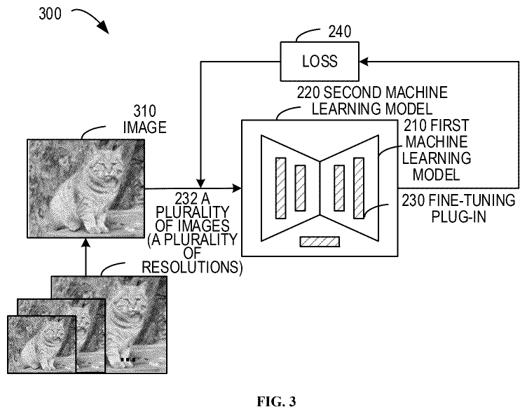

In order to at least partially solve the deficiencies in the prior art, according to an example implementation of the present disclosure, a method for generating an image is provided. Referring to FIG. 2, a summary is described according to an example implementation of the present disclosure. FIG. 2 illustrates a block diagram 200 for generating an image according to some implementations of the present disclosure. As illustrated in FIG. 2, a first machine learning model 210 may be obtained, and the first machine learning model 210 may be obtained based on a reference image (d) having a first resolution. For example, the first machine learning model may be trained based on a conventional resolution (e.g., 512×512, etc.). In this case, the image quality is generally higher when the first machine learning model outputs an image of 512×512.

Further, the fine-tuning may be performed on the first machine learning model by using a fine-tuning plug-in 230 (the box shown in the shadow format illustrated in the figure) to obtain the second machine learning model 220. Here, the fine-tuning plug-in 230 may be obtained based on a reference image(s) having a second resolution (e.g., different from the first resolution). For example, the fine-tuning plug-in 230 may be trained with a plurality of reference images 232 having a second resolution. In this case, the generated second machine learning model 220 may generate images of other resolutions. As illustrated in FIG. 2, the target image (for example, the image 250) may be generated by using the second machine learning model 220 based on the target prompt (for example, the prompt 240), and the target image may have a resolution and image content specified by the target prompt.

With the example implementation of the present disclosure, the fine-tuning plug-in 230 may obtain knowledge related to generating an image(s) with a further resolution(s) (different from the resolution of the training image), so that the second machine learning model may generate images with different resolutions in a more accurate and effective manner. It should be understood that, with respect to the first machine learning model, the fine-tuning plug-in relates to the resolution related knowledge, so that the amount of data is small, which is easier to be inserted into the existing machine learning model to support the multi-resolution adaptation function.

### Detailed Process of Image Generation

Having described a summary according to one example implementation of the present disclosure, more details regarding image generation will be described below. According to an example implementation of the present disclosure, the first machine learning model may be obtained based on currently known and/or future developed functional manners. According to one example implementation of the present disclosure, the first machine learning model includes a plurality of diffusion models having a plurality of architectures, respectively, and the fine-tuning plug-ins include a plurality of fine-tuning plug-ins respectively matching the plurality of diffusion models. According to example implementations of the present disclosure, corresponding fine-tuning plug-ins may be generated for machine learning models under different architectures, respectively, thereby expanding a plurality of different existing text-to-image models to a capability of supporting multi-resolution.

For example, the first machine learning model may be determined based on the architecture of the diffusion model, and specifically, the first machine learning model may be determined based on a stable diffusion (SD for short) architecture and/or an SDXL architecture. Further, corresponding fine-tuning plug-ins may be respectively generated for the diffusion models under different architectures, for example, respective fine-tuning plug-ins may be generated for models of the SD architecture and the SDXL architecture, respectively.

According to an example implementation of the present disclosure, the fine-tuning plug-in is obtained by: injecting the fine-tuning plug-in into the first machine learning model; and updating the injected fine-tuning plug-in based on the reference image having the second resolution. With example implementations of the present disclosure, fine-tuning plug-ins may be trained with images with different resolutions, thereby enabling the plug-in to have the ability to support images of different resolutions. Referring to FIG. 3, more details are described according to an example implementation of the present disclosure, and FIG. 3 illustrates a block diagram 300 for determining a fine-tuning plug-in according to some implementations of the present disclosure.

As illustrated in FIG. 3, a plurality of images 232 with different resolutions may be obtained. For example, images of different resolutions may be acquired from a plurality of image datasets currently known, for example, the resolutions may include 256×128, 256×256, 512×512, 768×768, 1024×768, 1024×1024, etc., and the aspect ratios of the plurality of images may be the same or different. The fine-tuning plug-in 230 may be injected to the first machine learning model 210, and then the fine-tuning plug-in 230 may be trained. For the image 310 in the plurality of images 232, the corresponding loss 240 may be determined using the image and the corresponding prompt, thereby updating the fine-tuning plug-in 230 in a direction that minimizes the loss 240. It should be understood that only the parameters of the injected fine-tuning plug-in 230 are updated, and the parameters of other portions of the first machine learning model 210 remain unchanged. In this way, the amount of data of the fine-tuning plug-in 230 can be maintained at a small amount of data, which is further convenient to be integrated into various text-to-image models.

According to an example implementation of the present disclosure, the fine-tuning plug-in may include at least one of the following: a parameter for fine-tuning a sampling network in the first machine learning model, the sampling network including an up-sampling network and a down-sampling network; or a parameter for fine-tuning a normalization module in a residual network in the first machine learning model. With the example implementations of the present disclosure, it can be ensured that the fine-tuning plug-in only updates the relevant part of the first machine learning model and the image resolution, so that the fine-tuned first machine learning model (i.e., the second machine learning model) can output the multi-resolution image with better visual effect without affecting other existing functions of the first machine learning model.

According to one example implementation of the present disclosure, a fine-tuning plug-in may be trained with a general-purpose image set with different resolutions. In this way, the image stylization function of the first machine learning model (i.e., the ability to generate images with different styles) is not affected, and multi-resolution adaptation is further supported on the basis of preserving the stylization capability.

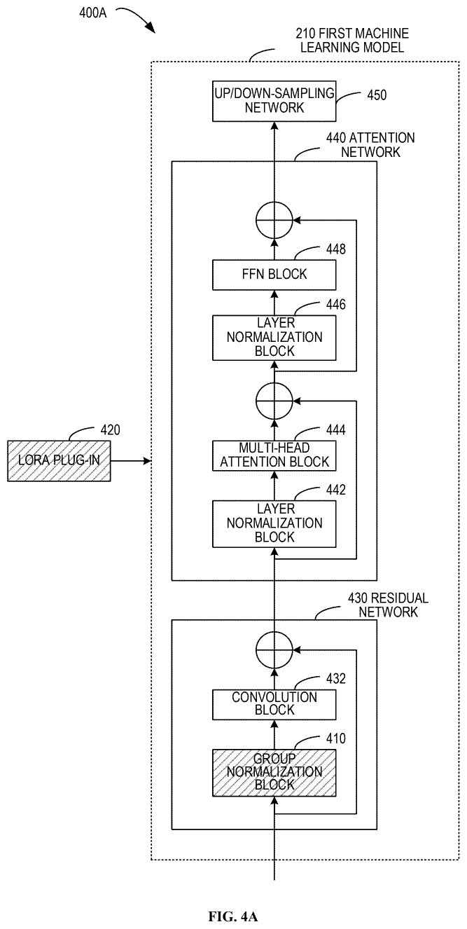

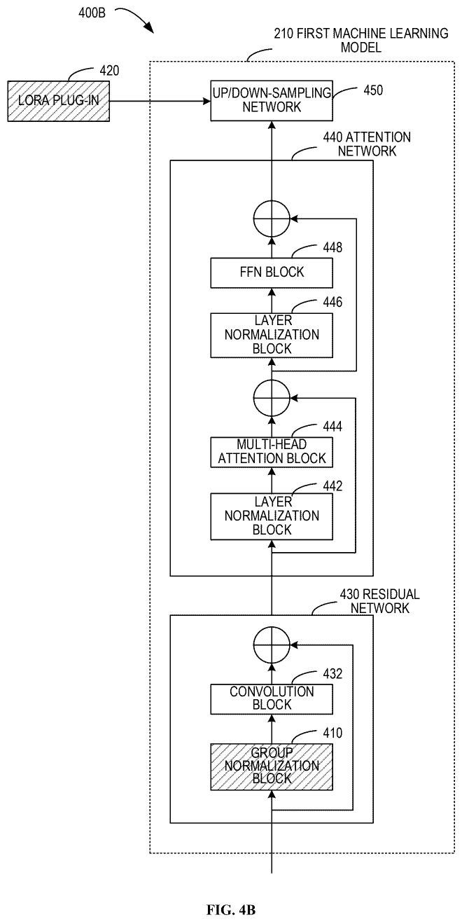

Referring to FIGS. 4A and 4B, more details are described in accordance with one example implementation of the present disclosure, which illustrates a block diagram 400A of injecting a fine-tuning plug-in to a first machine learning model, in accordance with some implementations of the present disclosure. As illustrated, modules of the fine-tuning plug-in are illustrated in a shaded box and other modules in the first machine learning model are illustrated in blank boxes. In this figure, the first machine learning model 210 may include a residual network 430, an attention network 440, and a up/down-sampling network 450. In a U network (UNet) used by the diffusion model, a downsampling network and an upsampling network may be respectively included.

The residual network may include a normalization module (e.g., a group normalization block 410) and a convolution block 432. It should be understood that, in the processing process, the normalization module is related to the image resolution and the size of the feature map, thereby affecting the processing performance of the model for images of different resolutions. In this case, the parameters of the group normalization block 410 need to be updated, thereby improving the multi-resolution processing capability of the model. The attention network 440 may include a plurality of modules, such as a layer normalization block 442, a multi-head attention block 444, and a subsequent layer normalization block 446 and a FFN (feed forward neural network) block 448.

A fine-tuning plug-in (such as the LoRA plug-in 420 in FIG. 4A) may be implemented based on a low-rank adaptation of Large Language Models (LoRA) technical solution. LoRA may implement customization requirements (e.g., generate images of a specified style, etc.) with a small amount of data without modifying the backbone model parameters of the SD, the required training resource is much less than training SD model. The parameters of the LoRA may be injected into the SD model, changing a portion of the functionality of the SD model, e.g., generating an image with a specified style, and so on. According to an example implementation of the present disclosure, the LoRA plug-in 420 supporting multi-resolution adaptation may be injected into the first machine learning model 210, and then the first machine learning model is converted into a second machine learning model supporting multi-resolution image generation.

It should be appreciated that if the LoRA plug-in 420 for supporting multi-resolution adaptation is injected into the attention network 440, it is possible to change the functionality of the customized image style of the first machine learning model 210. According to one example implementation of the present disclosure, the LoRA plug-in 420 may be injected into the up/down-sampling network 450 of the attention network 440. Further details are described with reference to FIG. 4B, which illustrates a block diagram 400B of injecting a fine-tuning plug-in into a first machine learning model, in accordance with some implementations of the present disclosure. It should be understood that FIG. 4B only schematically illustrates a part of the structure of the UNet in the diffusion model. As illustrated in FIG. 4B, the LoRA plug-in 420 may be injected into the down-sampling network. Similarly, in another part of the structure of UNet, a LoRA plug-in may be injected into the up-sampling network. With the example implementations of the present disclosure, the multi-resolution adaptation function may be further supported without affecting the customized image style function of the first machine learning model.

According to one example implementation of the present disclosure, the injected fine-tuning plug-ins may be updated with reference images of different resolutions. It should be understood that the plurality of resolutions herein may be other than the first resolution. In the process of updating the injected fine-tuning plug-in, a second plurality of reference images having the second resolution are determined; a second plurality of reference prompts respectively describing the second plurality of reference images are determined, the second plurality of reference prompts respectively comprising the second resolution. For example, here, the reference prompt may describe the content of the reference image, may construct the training sample according to the pairings of the text-images in the data set, or may construct the training sample in other manners.

Specifically, a reference image of 1024×1024 may be obtained, and a corresponding reference prompt “a yellow cat” may be determined. Alternatively and/or additionally, the reference prompt may include a resolution of the reference image. For example, the reference prompt may be “a yellow cat, resolution=1024*1024”. Alternatively and/or additionally, the reference prompt may include more or less content. Further, the fine-tuning plug-in is updated by using the second plurality of reference images and the second plurality of reference prompts. With the example implementations of the present disclosure, the fine-tuning plug-in may progressively obtain related indications of image generation with different resolutions, thereby supporting multi-resolution adaptation functions.

According to one example implementation of the present disclosure, the plurality of resolutions may include a first resolution for training an image of the first machine learning model. In particular, a first plurality of reference images having a first resolution may be determined, and a first plurality of reference prompts describing the first plurality of reference images, respectively, may be determined. Specifically, a reference image of 512×512 may be obtained, and a corresponding reference prompt “a yellow cat” may be determined. Alternatively and/or additionally, the reference prompt may include a resolution of the reference image. For example, the reference prompt may be “a yellow cat, resolution=512*512”. Alternatively and/or additionally, the reference prompt may include more or less content. Further, the fine-tuning plug-in may be updated by using the first plurality of reference images and the first plurality of reference prompts. With the example implementations of the present disclosure, it can be ensured that the fine-tuning plug-in does not forget the relevant knowledge about generating an image having the first resolution, thereby ensuring that the fine-tuned machine learning model can support the multi-resolution adaptation function in a more efficient manner.

According to an example implementation of the present disclosure, the number of the second reference images is not lower than the number of the first reference images. With the example implementation of the present disclosure, the fine-tuning plug-in can master more knowledge of generating images with different resolutions, thereby improving the efficiency of the fine-tuning process.

It should be understood that since the first machine learning model is determined by using a large number of reference images of the first resolution, the machine learning model may obtain better image quality when generating an image close to the first resolution (for example, a predetermined ratio range, such as 10%). However, when the machine learning model generates an image of a target resolution away from the first resolution, the image quality is poor. Generally, the larger the difference between the target resolution and the first resolution, the worse the generated image quality.

According to an example implementation of the present disclosure, in order to improve the quality of the generated image, the number of training images for each resolution may be different. Specifically, the number of the second plurality of reference images may be determined based on a difference between the second resolution and the first resolution. For example, the larger the difference between the second resolution and the first resolution is, the more the number of the second plurality of reference images having the second resolution may be. For example, the number of the second plurality of reference images may be based on a probability distribution function.

It is assumed that the multiple resolutions used to train the fine-tuning plug-ins include 256×128, 256×256, 512×512, 768×768, 1024×1024, and the number of reference images at each resolution is n1, n2, n, n3 and n4, respectively. In this case, based on the difference between each resolution and the first resolution 512×512, there may be the following relationship: n1>n2>n, and n4>n3>n. In this way, it may be ensured that the fine-tuning plug-in is able to grasp relevant knowledge about various images that generate various resolutions.

According to an example implementation of the present disclosure, the first machine learning model may be updated by using the fine-tuning plug-in obtained in the foregoing manner, and then the obtained second machine learning model is used to generate the image with the desired resolution. Further details are described with reference to FIG. 5, which illustrates a block diagram 500 of generating images with different resolutions using a second machine learning model, in accordance with some implementations of the present disclosure.

As illustrated in FIG. 5, in the fine-tuning process, a weight factor 512 associated with the fine-tuning plug-in may be determined based on the resolution specified by the target prompt 510, and the first machine learning model may be further fine-tuned based on the weight factor 512 and the fine-tuning plug-in, and then a plurality of images 520 having a plurality of different resolutions may be generated by using the obtained second machine learning model. It should be understood that, if the difference between the resolution specified by the target prompt and the first resolution is small, even if the fine adjustment plug-in is not used, the first machine learning model may generate an image with better quality. In this case, a smaller weight factor may be set and the influence of the fine-tuning plug-in on the first machine learning model may be weakened.

Alternatively, and/or additionally, if the difference between the resolution specified by the target prompt and the first resolution is large, the image quality generated directly using the first machine learning model is poor. In this case, a larger weight factor may be set and the influence of the fine-tuning plug-in on the first machine learning model may be enhanced, so that the fine-tuned second machine learning model may generate an image that is better in quality and have a resolution away from the first resolution. With example implementations of the present disclosure, the degree of influence of the fine-tuning plug-in can be flexibly adjusted, so that the fine-tuning process can be performed towards a direction that is more beneficial for generating a higher quality image.

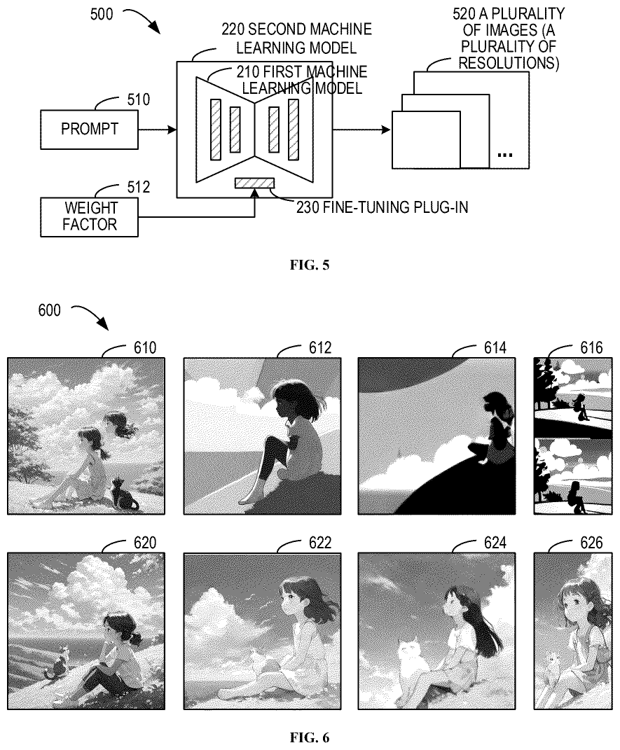

FIG. 6 illustrates a block diagram 600 of images generated with different technical solutions according to some implementations of the present disclosure. As illustrated in FIG. 6, images 610, 612, 614, and 616 represent images of different resolutions generated using known technical solutions, and resolutions of images 610, 612, 614, and 616 are: 1536×1536, 384×384, 256×256, and 288×512, respectively. It can be found that the above images have different degrees of quality problems, for example, the image 610 appears chaotic and two heads appear, the colors of the images 612 and 614 are dim, and the image 616 includes duplicate images and the colors are dim.

According to an example implementation of the present disclosure, a prompt may be specified, for example, “a girl sitting on the hill looking at the sky, with her hair blowing in a clear day, with a cat . . . ”. Further, the prompt may specify generating a plurality of images with the following resolutions: 1536×1536, 384×384, 256×256, and 288×512. Images 620, 622, 624, and 626 represent images of respective resolutions generated using the proposed technical solutions, the content of these images is realistic and color bright, and the overall visual effect is greatly superior to images 610 through 616. It should be understood that while a prompt is provided in English as an example, a prompt may alternatively and/or additionally be written in other languages (e.g., Chinese, French, etc.).

In the context of the present disclosure, the fine-tuning process described above may be combined with a downstream model of image processing to obtain higher image quality and/or higher processing efficiency. It should be understood that if a machine learning model is directly utilized to generate higher resolution images, larger computing resource overhead and longer processing time may result. Thus, an image having a medium resolution may be generated first, and then a higher resolution image is generated based on an existing super-resolution process.

According to an example implementation of the present disclosure, when a prompt for generating an image having a third resolution is received, an intermediate image having a second resolution may be generated based on the prompt and using a second machine learning model, the third resolution being higher than the second resolution. Further, the output image having the third resolution may be generated using the third machine learning model based on the intermediate image. With the example implementation of the present disclosure, the overall calculation amount and time overhead of generating the image of the third resolution may be reduced.

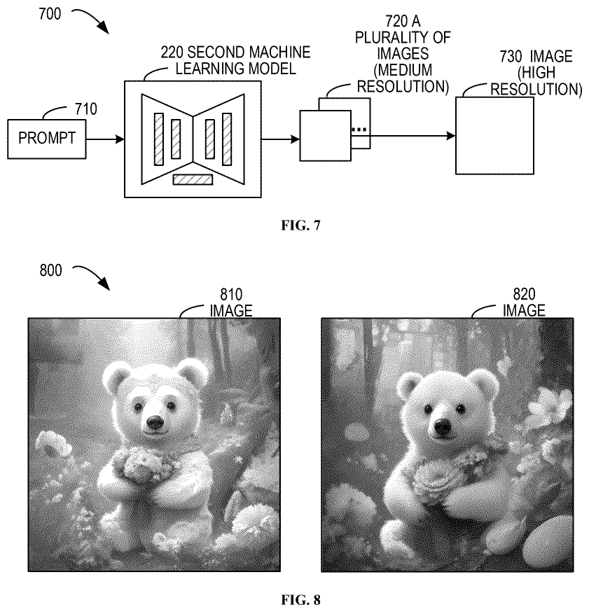

More details are described with reference to FIG. 7, which illustrates a block diagram 700 for generating a high resolution image, in accordance with some implementations of the present disclosure. As illustrated in FIG. 7, it is assumed that the first machine learning model is obtained with a reference image of 512×512, and the prompt 710 indicates that an image with a resolution of 2048×2048 is desired to be generated. In this case, a plurality of images 720 having a medium resolution may be first generated using the second machine learning model 220.

Specifically, the third resolution in the prompt 710 may be updated to a lower second resolution, and the intermediate image having the second resolution may be generated using the second machine learning model based on the prompt. Further, the high-resolution image 730 may be generated using a third machine learning model that implements super-resolution processing.

FIG. 8 illustrates a block diagram 800 of high-resolution images generated with different technical solutions according to some implementations of the present disclosure. For example, a plurality of images with a resolution of 1024×1024 may be generated first, and then an image 810 with a resolution of 2048×2048 is generated using an elastic diffusion model. Alternatively and/or additionally, a plurality of images with a resolution of 768×768 may be generated first, followed by an elastic diffusion model to generate an image 820 with a resolution of 2048×2048. The experimental data illustrates that, relative to generating the image 810, the speed of generating the image 820 increases by 44%, and the visual effects of the two images 810 and 820 do not have a significant difference. It should be understood that although only one downstream task is described above with reference to generating a higher resolution image as an example, the proposed technical solution for generating a multi-resolution image may be combined with other downstream tasks, thereby implementing other downstream tasks.

With the example implementation of the present disclosure, the fine-tuning plug-in may obtain the related knowledge of the images with other resolutions, so that the fine-tuned second machine learning model may generate images with different resolutions in a more accurate and effective manner.

Details regarding the various steps of image generation have been described above, and in the following, an overall process for generating an image using a machine learning model will be described. The text-to-image model and corresponding personalization techniques may support generating high quality, imaginative images. However, since the receptive field of the convolutional layer in the U network of the diffusion model does not match the feature map size of the image, and the normalization cannot accommodate the statistical distribution of the feature maps in images with a plurality of resolutions, the quality will be significantly reduced when the resolution of the image generated by the model is away from the resolution of the training image.

To this end, a domain coherence resolution adapter (e.g., named as ResAdapter) for supporting a personalized diffusion model is presented. Here, the resolution adaptation may include resolution extrapolation and interpolation. Resolution extrapolation may refer to generating an image having a resolution (e.g., 1536×1536) higher than the training resolution (e.g., 512×512). Resolution interpolation may refer to generating an image having a resolution (e.g., 256×256) lower than the training resolution. The relevant knowledge of the resolution can be learned from the general image data centrally and saved into the fine-tuning plug-in ResAdapter. Further, ResAdapter may be integrated into various personalized diffusion models to generate images with a plurality of resolutions.

The ResAdapter may include two components: resolution IoRA (ResLoRA, LoRA plug-in 420 as illustrated in FIG. 4) and resolution normalization (ResNorm, group normalization block 410 as illustrated in FIG. 4). The ResLoRA may improve the poor fidelity of the multi-resolution images and only be inserted into the resolution aware structure of the UNet so that the receptive field of the convolution in the UNet block matches the feature map size of the images with different resolution. Further, ResNorm focuses on improving the layout of duplicate objects and can adapt to statistical distribution of feature maps of multi-resolution images. In this way, the ResAdapter may learn the relevant knowledge of the resolution and be integrated into any personalized model without involving a stylistic domain transformation to generate a multi-resolution image.

With the advent of large-scale datasets, the parameter count of the diffusion model has reached a billion level. Full parameter fine-tuning requires very high training costs in specific downstream tasks, while also causing catastrophic forgetting. According to one example implementation of the present disclosure, fine-tuning is not performed for the entire diffusion model, but only small-scale fine-tuning plug-ins are generated based on the diffusion model. According to an example implementation of the present disclosure, the ResAdapter may be trained using reference images of different resolutions in a customized diffusion model, so that the fine-tuned machine learning model generates a high-quality image with rich imagination. Here, the ResAdapter can be lightweight, and the number of the trainable parameters is 0.55M, thereby realizing low-cost training and efficient reasoning. The ResAdapter may be compatible with other downstream models, for example, the generation efficiency of other multi-resolution models may be optimized.

The generation process of the diffusion model includes forward diffusion and reverse denoising processes. Given one data sample X₀˜q_{data}(x), the diffusion model progressively injects small Gaussian noise into the data and generates samples by inverse denoising. Specifically, the forward diffusion process of the diffusion model is controlled by the Markov chain as q(xₜ|xₜ₋₁)= [symbol] (xₜ; \sqrt{1−β}ₜxₜ₋₁, βₜI), wherein Pt is a variance schedule between 0 and 1. By using the reparameterization technique, the data distribution q_{data}(x) may be converted to a marginal distribution q(xₜ|x₀). q(xₜ|x₀)= [symbol] (xₜ; \sqrt{α̅ₜ}x₀, (1−α̅ₜ)I) may be obtained by using symbols: αₜ: =1−βₜ, and α̅ₜ: =Πₛ₌₁^{t}αₛ.

In the reverse process, the diffusion model learns to gradually reduce the small Gaussian noise:

$${p}_{θ} ( {x}_{t - 1} \vert {x}_{t} ) = 𝒩 ( {x}_{t - 1} ; {μ}_{θ} ( {x}_{t} , t ) , {σ}_{t}^{2} I ) ,$$

$$where {μ}_{θ} ( {x}_{t} , t ) = \frac{1}{\sqrt{{α}_{t}}} ( {x}_{t} - \frac{{β}_{t}}{\sqrt{1 - {\overline{α}}_{t}}} {ϵ}_{θ} ( {x}_{t} , t ) .$$

The corresponding objective function is the variational lower bound of the negative log-likelihood. The following may be obtained: [symbol] (θ)=Σₜ [symbol] _{KL}(q(xₜ₋₁|xₜ, x₀)|p_{θ}(xₜ₋₁|xₜ)−p_{θ}(x₀|x₁), where [symbol] _{KL} represents a divergence between the distributions p and q. Furthermore, through the parameterization μ_{θ}(xₜ, t), the loss function can be simplified as:

$${L}_{s i m p l e} = {𝔼}_{{x}_{0} , ϵ , t} [ {‖ ϵ - {ϵ}_{θ} ( \sqrt{{\overline{α}}_{t}} {x}_{0} + \sqrt{1 - {\overline{α}}_{t}} ϵ , t ) ‖}^{2} ] \qquad Equation 1$$

The training objective in this formulation is minimizing the squared error between the gaussian noise and the estimated noise of the noise-added samples.

To reduce the training cost of the diffusion model and generate a high-resolution image, the SD model may encode the image using a variational autoencoder. SD performs forward and reverse denoising in latent space. Specifically, given the data x₀˜q_{data}(x), the encoder ε encodes the image into z₀=ε(x₀). For latent representations generated by the diffusion model in latent space, the decoder [symbol] may reconstruct it as an image. In SD, the encoder typically down-samples an image by a factor f=8. A loss function may be obtained:

$${L}_{s i m p l e} = {𝔼}_{{z}_{0} , ϵ , t} [ {‖ ϵ - {ϵ}_{θ} ( \sqrt{{\overline{α}}_{t}} {z}_{0} + \sqrt{1 - {\overline{α}}_{t}} ϵ , t ) ‖}^{2} ] \qquad Equation 2$$

According to an example implementation of the present disclosure, the ResAdapter may be trained on the basis of the SD model described above.

Personalized LoRA enables basic models (e.g., SD and SDXL) to generate personalized images. The reason for poor image fidelity is that the perceptual range of the convolution does not match the feature map size of the multi-resolution image. Thus, the ResloRA can be inserted into the convolution of the UNet to learn the relevant knowledge of the resolution. In order to prevent ResloRA from modifying the style-related function of the model, two low-rank matrices of the ResloRA are inserted into the up-sampling and down-sampling networks illustrated in FIG. 4B. The resolution is low level knowledge compared to style related knowledge, and thus involves only a smaller amount of data.

The ResloRA is only valid in the resolution interpolation of the personalized model, but is invalid in resolution extrapolation. For example, in a case where only ResloRA is used, duplicate object layouts are still generated when generating higher resolution images (e.g., 768×768, 1024×1024). Since the resolution extrapolation failure is limited by the capability of the normalization layer, that is, the existing normalization layer cannot adapt to the statistical distribution of the feature maps of multi-resolution images. Therefore, in order to maintain compatibility of the normalization layers trained on the data set, ResNorm is provided to modify the group normalization block, thereby achieving resolution extrapolation of the model.

The ResAdapter may be trained using images with multiple different resolutions. Specifically, a simple hybrid resolution training strategy is provided. For SD, training may be performed on a universal set of image data having a conventional resolution of 256×256 to 1024×1024. For SDXL, training may be performed on a universal set of image data having a conventional resolution of 256×256 to 1536×1536. In this way, ResAdapter can be allowed to learn multi-resolution knowledge at the same time and prevent catastrophic forgetting.

It should be appreciated that images (e.g., 256×256 and 1024×1024) away from the resolution of the training data (e.g., 512×512) are more difficult to train. To mitigate this phenomenon, a simple probability function may be used to sample images with different resolutions at different probabilities. For example, the probability function may be expressed as:

$$P ( x ) = \frac{{\vert x - r \vert}^{2}}{{\sum }_{i}^{N} {\vert {x}_{i} - r \vert}^{2}} .$$

Here, r represents the first resolution (e.g., 512×512) and x represents the resolution of the training image. In this way, in the multi-resolution training process, the probability of selecting the training image away from the first resolution may be improved. Further, multi-resolution image training (e.g., different aspect ratios: 16:9, 4:3, 3:2, etc.) may be introduced.

With example implementations of the present disclosure, ResAdapter implements a lightweight domain consistency readapter for personalized text-to-image diffusion models that enables resolution extrapolation and interpolation of personalized models. Through the training process described above, a fine-tuning plug-in with a smaller data volume can be generated, and then the fine-tuning plug-in can be integrated into the personalized model, thereby generating a high-quality multi-resolution image without converting the style field.

### Example Processes

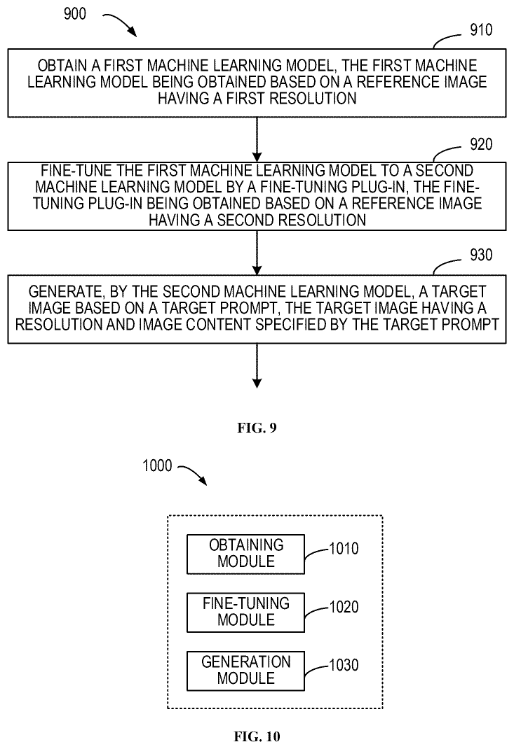

FIG. 9 illustrates a flowchart of a method 900 for generating an image according to some implementations of the present disclosure. At block 910, a first machine learning model is obtained, the first machine learning model being obtained based on a reference image having a first resolution. At block 920, the first machine learning model is fine-tuned to the second machine learning model by a fine-tuning plug-in that is obtained based on a reference image having a second resolution. At block 930, based on the target prompt, a target image is generated by the second machine learning model, the target image having a resolution and image content specified by the target prompt.

According to an example implementation of the present disclosure, the fine-tuning plug-in is obtained by: injecting the fine-tuning plug-in into the first machine learning model; and updating the injected fine-tuning plug-in based on the reference image having the second resolution.

According to an example implementation of the present disclosure, the fine-tuning plug-in comprises at least any of: a parameter for fine-tuning a sampling network in the first machine learning model, the sampling network including an up-sampling network and a down-sampling network; or a parameter for fine-tuning a normalization module in a residual network in the first machine learning model.

According to an example implementation of the present disclosure, updating the injected fine-tuning plug-in further comprises: determining a first plurality of reference images having the first resolution; determining a first plurality of reference prompts respectively describing the first plurality of reference images, the first plurality of reference prompts respectively comprising the first resolution; and updating the fine-tuning plug-in based on the first plurality of reference images and the first plurality of reference prompts.

According to one example implementation of the present disclosure, updating the injected fine-tuning plug-in comprises: determining a second plurality of reference images having the second resolution; determining a second plurality of reference prompts respectively describing the second plurality of reference images, the second plurality of reference prompts respectively comprising the second resolution; and updating the fine-tuning plug-in based on the second plurality of reference images and the second plurality of reference prompts.

According to an example implementation of the present disclosure, the method further includes: determining a number of the second plurality of reference images based on a difference between the second resolution and the first resolution.

According to an example implementation of the present disclosure, a number of the second reference images is greater than or equal to a number of the first reference images.

According to an example implementation of the present disclosure, fine tuning the first machine learning model to the second machine learning model by the fine-tuning plug-in comprises: determining a weight factor associated with the fine-tuning plug-in based on the resolution specified by the target prompt; and fine-tuning the first machine learning model based on the weight factor and the fine-tuning plug-in.

According to an example implementation of the present disclosure, the method further includes: in response to receiving a prompt for generating an image having a third resolution, generating, by the second machine learning model, an intermediate image having the second resolution based on the prompt, the third resolution being higher than the second resolution; and generating, by a third machine learning model, an output image having the third resolution based on the intermediate image.

According to an example implementation of the present disclosure, generating the intermediate image includes: updating the third resolution in the prompt to the second resolution; and generating, by the second machine learning model, the intermediate image having the second resolution based on the prompt.

According to one example implementation of the present disclosure, the first machine learning model comprises a plurality of diffusion models having a plurality of architectures, respectively, and the fine-tuning plug-in comprises a plurality of fine-tuning plug-ins respectively matching the plurality of diffusion models.

### Example Apparatus and Device

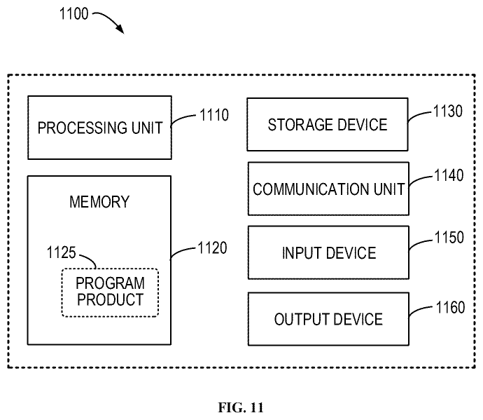

FIG. 10 illustrates a block diagram of an apparatus 1000 for generating an image according to some implementations of the present disclosure. The apparatus 1000 includes: an obtaining module 1010configured to obtain a first machine learning model, the first machine learning model being obtained based on a reference image having a first resolution; a fine-tuning module 1020 configured to fine-tune the first machine learning model to a second machine learning model by a fine-tuning plug-in, the fine-tuning plug-in being obtained based on a reference image having a second resolution; and a generation module 1030 configured to generate, by the second machine learning model, a target image based on a target prompt, the target image having a resolution and image content specified by the target prompt.

According to an example implementation of the present disclosure, the fine-tuning plug-in is obtained by: an injection module configured to inject the fine-tuning plug-in into the first machine learning model; and an updating module configured to update the injected fine-tuning plug-in based on the reference image having the second resolution.

According to an example implementation of the present disclosure, the fine-tuning plug-in comprises at least any of: a parameter for fine-tuning a sampling network in the first machine learning model, the sampling network including an up-sampling network and a down-sampling network; or a parameter for fine-tuning a normalization module in a residual network in the first machine learning model.

According to an example implementation of the present disclosure, the updating module further includes: a first image determining module, configured to determine a first plurality of reference images having the first resolution; a first prompt determining module, configured to determine a first plurality of reference prompts respectively describing the first plurality of reference images, the first plurality of reference prompts respectively comprising the first resolution; and a first updating module, configured to update the fine-tuning plug-in based on the first plurality of reference images and the first plurality of reference prompts.

According to an example implementation of the present disclosure, the updating module further includes: a second image determining module, configured to determine a second plurality of reference images having the second resolution; a second prompt determining module, configured to determine a second plurality of reference prompts respectively describing the second plurality of reference images, the second plurality of reference prompts respectively comprising the second resolution; and a second updating module, configured to update the fine-tuning plug-in based on the second plurality of reference images and the second plurality of reference prompts.

According to an example implementation of the present disclosure, the apparatus further includes: a number determining module configured to determine a number of the second plurality of reference images based on a difference between the second resolution and the first resolution.

According to an example implementation of the present disclosure, a number of the second reference images is greater than or equal to a number of the first reference images.

According to an example implementation of the present disclosure, the fine-tuning module includes: a weight determining module configured to determine a weight factor associated with the fine-tuning plug-in based on the resolution specified by the target prompt; and a model fine-tuning module configured to fine-tune the first machine learning model based on the weight factor and the fine-tuning plug-in.

According to an example implementation of the present disclosure, the apparatus further includes: an intermediate image generation module configured to in response to receiving a prompt for generating an image having a third resolution, generate, by the second machine learning model, an intermediate image having the second resolution based on the prompt, the third resolution being higher than the second resolution; and an output module configured to generate, by a third machine learning model, an output image having the third resolution based on the intermediate image.

According to an example implementation of the present disclosure, the intermediate image generation module includes: a resolution updating module, configured to update the third resolution in the prompt to the second resolution; and a calling module, configured to generate, by the second machine learning model, the intermediate image having the second resolution based on the prompt.

According to one example implementation of the present disclosure, the first machine learning model comprises a plurality of diffusion models having a plurality of architectures, respectively, and the fine-tuning plug-in comprises a plurality of fine-tuning plug-ins respectively matching the plurality of diffusion models.

FIG. 11 illustrates a block diagram of a device 1100 capable of implementing various implementations of the present disclosure. It should be understood that the computing device 1100 illustrated in FIG. 11 is merely example and should not constitute any limitation on the functionality and scope of the implementations described herein. The computing device 1100 illustrated in FIG. 11 may be configured to implement the method described above.

As illustrated in FIG. 11, the computing device 1100 is in the form of a general-purpose computing device. Components of the computing device 1100 may include, but are not limited to, one or more processors or a processing unit 1110, a memory 1120, a storage device 1130, one or more communication units 1140, one or more input devices 1150, and one or more output devices 1160. The processing unit 1110 may be an actual or virtual processor and capable of performing various processes according to programs stored in the memory 1120. In multiprocessor systems, multiple processing units execute computer-executable instructions in parallel to improve parallel processing capabilities of computing device 1100.

Computing device 1100 typically includes a plurality of computer storage media. Such media may be any available media accessible by the computing device 1100, including, but not limited to, volatile and non-volatile media, removable and non-removable media. The memory 1120 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1130 may be a removable or non-removable medium and may include a machine-readable medium, such as a flash drive, magnetic disk, or any other medium, which may be capable of storing information and/or data (e.g., training data for training) and may be accessed within computing device 1100.

The computing device 1100 may further include additional removable/non-removable, volatile/non-volatile storage media. Although not illustrated in FIG. 11, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not illustrated) by one or more data media interfaces. The memory 1120 may include a computer program product 1125 having one or more program modules configured to perform various methods or actions of various implementations of the present disclosure.

The communications unit 1140 implements communications with other computing devices over a communications medium. Additionally, the functionality of components of the computing device 1100 may be implemented in a single computing cluster or multiple computing machines capable of communicating over a communication connection. Thus, the computing device 1100 may operate in a networked environment using logical connections with one or more other servers, network personal computers (PCs), or another network node.

The input device 1150 may be one or more input devices such as a mouse, a keyboard, a trackball, or the like. The output device 1160 may be one or more output devices, such as a display, a speaker, a printer, or the like. Computing device 1100 may also communicate with one or more external devices (not illustrated) as needed, external devices such as storage devices, display devices, etc., communicate with one or more devices that enable a user to interact with computing device 1100, or communicate with any device (e.g., network card, modem, etc.) that enables computing device 1100 to communicate with one or more other computing devices. Such communication may be performed via an input/output (I/O) interface (not illustrated).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above. According to example implementations of the present disclosure, there is provided a computer program product having stored thereon a computer program, which when executed by a processor, implements the method described above.

Aspects of the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block(s) in block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

What is claimed is:

1. A method for generating an image, comprising:
obtaining a first machine learning model, the first machine learning model being obtained based on a reference image having a first resolution;
fine-tuning the first machine learning model to a second machine learning model by a fine-tuning plug-in, the fine-tuning plug-in being obtained based on a reference image having a second resolution; and
generating, by the second machine learning model, a target image based on a target prompt, the target image having a resolution and image content specified by the target prompt.

2. The method of claim 1, wherein the fine-tuning plug-in is obtained by:
injecting the fine-tuning plug-in into the first machine learning model; and
updating the injected fine-tuning plug-in based on the reference image having the second resolution.

3. The method of claim 1, wherein the fine-tuning plug-in comprises at least any of:
a parameter for fine-tuning a sampling network in the first machine learning model, the sampling network including an up-sampling network and a down-sampling network; or
a parameter for fine-tuning a normalization module in a residual network in the first machine learning model.

4. The method of claim 2, wherein updating the injected fine-tuning plug-in further comprises:
determining a first plurality of reference images having the first resolution;
determining a first plurality of reference prompts respectively describing the first plurality of reference images, the first plurality of reference prompts respectively comprising the first resolution; and
updating the fine-tuning plug-in based on the first plurality of reference images and the first plurality of reference prompts.

5. The method of claim 4, wherein updating the injected fine-tuning plug-in comprises:
determining a second plurality of reference images having the second resolution;
determining a second plurality of reference prompts respectively describing the second plurality of reference images, the second plurality of reference prompts respectively comprising the second resolution; and
updating the fine-tuning plug-in based on the second plurality of reference images and the second plurality of reference prompts.

6. The method of claim 5, further comprising:
determining a number of the second plurality of reference images based on a difference between the second resolution and the first resolution.

7. The method of claim 5, wherein a number of the second reference images is greater than or equal to a number of the first reference images.

8. The method of claim 1, wherein fine tuning the first machine learning model to the second machine learning model by the fine-tuning plug-in comprises:
determining a weight factor associated with the fine-tuning plug-in based on the resolution specified by the target prompt; and
fine-tuning the first machine learning model based on the weight factor and the fine-tuning plug-in.

9. The method of claim 1, further comprising:
in response to receiving a prompt for generating an image having a third resolution, generating, by the second machine learning model, an intermediate image having the second resolution based on the prompt, the third resolution being higher than the second resolution; and
generating, by a third machine learning model, an output image having the third resolution based on the intermediate image.

10. The method of claim 1, wherein generating the intermediate image comprises:
updating the third resolution in the prompt to the second resolution; and
generating, by the second machine learning model, the intermediate image having the second resolution based on the prompt.

11. The method of claim 1, wherein the first machine learning model comprises a plurality of diffusion models having a plurality of architectures, respectively, and the fine-tuning plug-in comprises a plurality of fine-tuning plug-ins respectively matching the plurality of diffusion models.

12. An electronic device, comprising:
at least one processing unit; and
at least one memory coupled to the at least one processing unit and storing instructions executable by the at least one processing unit, the instructions, when executed by the at least one processing unit, causing the electronic device to perform acts comprising:
obtaining a first machine learning model, the first machine learning model being obtained based on a reference image having a first resolution;
fine-tuning the first machine learning model to a second machine learning model by a fine-tuning plug-in, the fine-tuning plug-in being obtained based on a reference image having a second resolution; and
generating, by the second machine learning model, a target image based on a target prompt, the target image having a resolution and image content specified by the target prompt.

13. The electronic device of claim 12, wherein the fine-tuning plug-in is obtained by:
injecting the fine-tuning plug-in into the first machine learning model; and
updating the injected fine-tuning plug-in based on the reference image having the second resolution.

14. The electronic device of claim 12, wherein the fine-tuning plug-in comprises at least any of:
a parameter for fine-tuning a sampling network in the first machine learning model, the sampling network including an up-sampling network and a down-sampling network; or
a parameter for fine-tuning a normalization module in a residual network in the first machine learning model.

15. The electronic device of claim 14, wherein updating the injected fine-tuning plug-in further comprises:
determining a first plurality of reference images having the first resolution;
determining a first plurality of reference prompts respectively describing the first plurality of reference images, the first plurality of reference prompts respectively comprising the first resolution; and
updating the fine-tuning plug-in based on the first plurality of reference images and the first plurality of reference prompts.

16. The electronic device of claim 12, wherein fine tuning the first machine learning model to the second machine learning model by the fine-tuning plug-in comprises:
determining a weight factor associated with the fine-tuning plug-in based on the resolution specified by the target prompt; and
fine-tuning the first machine learning model based on the weight factor and the fine-tuning plug-in.

17. The electronic device of claim 12, further comprising:
in response to receiving a prompt for generating an image having a third resolution, generating, by the second machine learning model, an intermediate image having the second resolution based on the prompt, the third resolution being higher than the second resolution; and
generating, by a third machine learning model, an output image having the third resolution based on the intermediate image.

18. The electronic device of claim 12, wherein generating the intermediate image comprises:
updating the third resolution in the prompt to the second resolution; and
generating, by the second machine learning model, the intermediate image having the second resolution based on the prompt.

19. The electronic device of claim 12, wherein the first machine learning model comprises a plurality of diffusion models having a plurality of architectures, respectively, and the fine-tuning plug-in comprises a plurality of fine-tuning plug-ins respectively matching the plurality of diffusion models.

20. A non-transitory computer-readable storage medium having a computer program stored thereon, the computer program, when executed by a processor, causes the processor to implement acts comprising:
obtaining a first machine learning model, the first machine learning model being obtained based on a reference image having a first resolution;
fine-tuning the first machine learning model to a second machine learning model by a fine-tuning plug-in, the fine-tuning plug-in being obtained based on a reference image having a second resolution; and
generating, by the second machine learning model, a target image based on a target prompt, the target image having a resolution and image content specified by the target prompt.
